(19) United States
(12) Patent Application Publication
(10) Pub. No.: US 2020/0240775 A1
(43) Pub. Date: Jul. 30, 2020

(54) DEVICE AND METHOD FOR DEMARCATING CENTER LINE OF AUTOMOBILE BODY

(71) Applicant: AUTEL INTELLIGENT TECHNOLOGY CORP., LTD., Shenzhen (CN)

(72) Inventors: Xuelong Qiu, Shenzhen (CN); Zhiqin Shen, Shenzhen (CN); Jin Chen, Shenzhen (CN)

(21) Appl. No.: 16/852,719

(22) Filed: Apr. 20, 2020

Related U.S. Application Data
(63) Continuation-in-part of application No. PCT/CN2018/110090, filed on Oct. 12, 2018.

(30) Foreign Application Priority Data
Oct. 20, 2017 (CN) 201710987229.2

(51) Int. Cl. G01B 11/275

(52) U.S. Cl. CPC G01B 11/275; G01B 2210/12; G01B 2210/306

(57) ABSTRACT

The present invention relates to the technical field of automobile maintenance and device demarcation, and discloses a device and a method for demarcating a center line of an automobile body, the demarcation device including a holder apparatus and a laser. The holder apparatus includes a horizontal scale, and the laser is installed on the automobile body and is configured to emit a laser beam to the horizontal scale. According to the device for demarcating a center line of an automobile body, the lasers may be installed on wheels on both sides of an automobile, two laser beams equidistantly emitted using the wheels as reference points irradiate at the horizontal scale, and the holder apparatus may be moved to an appropriate position according to a graduation of the horizontal scale, thereby facilitating demarcation of the center line of the automobile.

### CROSS-REFERENCE TO RELATED APPLICATIONS

The application is a continuation-in-part of International Patent Application No. PCT/CN2018/110090 filed on Oct. 12, 2018, which claims priority to Chinese Patent Application No. 201710987229.2 filed on Oct. 20, 2017, both of which are incorporated by reference herein in their entireties.

### TECHNICAL FIELD

This application relates to the technical field of vehicle maintenance and device demarcation, and in particular, to a device and a method for demarcating a center line of an automobile body.

### BACKGROUND

In the field of vehicle maintenance, during four-wheel alignment and calibration of an advanced driver assistant systems (ADAS), etc., a center line of an automobile body is required to be demarcated, to facilitate subsequent placement of a calibration device.

Alignment of a device center with an automobile body center, placement of a device at an interval of a distance from an automobile body, and enabling of a device to be perpendicular to a central plane of an automobile body, etc. all require demarcation of a center line of an automobile body.

During implementation of the present invention, the applicant finds the following disadvantages of an existing manner demarcating of a center line:

1. Large error as a result of imprecise demarcation. In the existing demarcation manner, two points are respectively marked on the ground in front of and behind an automobile through a plumb line and using centers of a front part and a rear portion of the automobile, such as a logo of the automobile, a license plate of the automobile, wipers of the automobile, a tail antenna of the automobile, a center with equal distances to front wheels or to rear wheels, etc. as central reference points, and a center line of the automobile body is demarcated using the two points as a standard. According to Two Point One Line in geometric mathematics, in the method, the center line of the automobile body can be determined, but the two marked points are merely marks obtained through extension of the central reference points of the automobile body. If an error occurs during extension, the demarcated center line is incorrect. In addition, the extended central reference point of the automobile body is principally based on human eye vision, and a ground reference point varies according to a position of human eyes, resulting in inaccurate demarcated center line.

2. Inconvenient operation. In the existing method, after the extended front and rear reference points on the ground are determined, a rope is required to pass through a bottom of the automobile to be straightened to the determined reference points on the ground respectively, and then the center line of the vehicle is demarcated using the rope as a reference. This method requires cooperation of at least two persons, and it is very inconvenient to make the rope pass through the bottom of the automobile. In addition, introducing the rope as a reference is equivalent to introducing a reference variable, reducing accuracy of demarcation.

### SUMMARY

In order to resolve the foregoing technical problems, embodiments of the present invention provide a device and a method for demarcating a center line of an automobile body facilitating a demarcation operation.

In the embodiments of the present invention, the technical problems are resolved using the following technical solutions.

A device for demarcating a center line of an automobile body is provided, including a holder apparatus and a laser. The holder apparatus includes a horizontal scale, and the laser is installed on the automobile body and is configured to emit a laser beam to the horizontal scale.

Optionally, the holder apparatus includes a guide rail, the horizontal scale being disposed on the guide rail, and the horizontal scale extending along both sides of the guide rail respectively using a center of the guide rail as a zero point.

Optionally, the device for demarcating a center line of an automobile body includes a reflecting mirror and a diaphragm. The holder apparatus includes a sliding member, the sliding member being movably installed on the guide rail and being movable along the guide rail, and the horizontal scale being configured to facilitate fixing of the sliding member. The reflecting mirror is installed on the sliding member, and the reflecting mirror may slide with the sliding member along the guide rail. The diaphragm is configured to control the laser beam to pass therethrough, and the reflecting mirror is configured to reflect, to the laser, the laser beam that passes through the diaphragm.

Optionally, the diaphragm is provided with a strip-shaped diaphragm groove configured to control the laser beam to pass therethrough.

Optionally, the diaphragm includes a fixing base and a sliding diaphragm, the sliding diaphragm being provided with the diaphragm groove, and the sliding diaphragm being installed on the fixing base. A position of the sliding diaphragm on the fixing base is adjustable.

Optionally, the fixing base includes a base, a fixing support, and a locking handle. One end of the fixing support is installed at the base, the fixing support is strip-shaped, and the locking handle is installed on the fixing support. The sliding diaphragm includes a diaphragm portion and a sliding groove portion. The diaphragm portion is tabular and is provided with the diaphragm groove. The sliding groove portion is installed at the diaphragm portion, and the sliding groove portion is strip-shaped and movably sleeved around the fixing support. The sliding groove portion is provided with a strip-shaped groove, and the locking handle passes through the groove for fixing the sliding diaphragm on the fixing base.

Optionally, the laser includes an emitting portion, an installing shaft, and an observing target. The emitting portion is configured to emit the laser beam. The installing shaft is installed on the emitting portion for installing the laser on a wheel of the automobile. The observing target is installed on the emitting portion, and the observing target includes an observing target face for displaying a position of the laser beam reflected back through the reflecting mirror. An emitting hole is provided at a center of the observing target face.

Optionally, the holder apparatus includes a holder assembly and a cross beam assembly. The cross beam assembly is installed on the holder assembly and may vertically move relative to the holder assembly. The cross beam assembly includes the guide rail, the guide rail being horizontally disposed.

Optionally, the holder assembly includes a holder body and a height adjusting member. At least three of the height adjusting members are installed on a bottom surface of the holder body for adjusting an overall horizontal angle of the holder body and a pitch angle of the holder body.

Optionally, there are three height adjusting members, and the three height adjusting members are distributed in a form of an isosceles triangle. The three height adjusting members are configured to cooperate to adjust the overall horizontal angle of the holder body, and the height adjusting member located at a top point of an apical angle of the isosceles triangle is configured to adjust the pitch angle of the holder body.

Optionally, the holder assembly includes a base holder and a vertical-rod support. One end of the vertical-rod support is connected to the base holder, the base holder supporting the vertical-rod support. The cross beam assembly is installed on the vertical-rod support. The base holder includes a rolling wheel, the holder body, and the height adjusting member. At least three of the rolling wheels are installed on a bottom surface of the holder body to facilitate movement of the base support.

Optionally, the vertical-rod support includes a lifting screw rod. The lifting screw rod is vertically disposed. The cross beam assembly is sleeved around the lifting screw rod and is in screw-thread fit with the lifting screw rod. When the lifting screw rod rotates around a central axis of the lifting screw rod, the lifting screw rod is capable of driving the cross beam assembly to vertically move along the lifting screw rod.

Optionally, the vertical-rod support includes a lifting guide rail. The lifting guide rail includes a vertical rod, the vertical rod being vertically disposed. The cross beam assembly is movably installed on the vertical rod, the vertical rod being configured to guide the cross beam assembly to vertically move.

Optionally, the lifting guide rail includes a horizontal rod, the horizontal rod being horizontally installed at the vertical rod. One end of the lifting screw rod is installed at the horizontal rod, and the other end of the lifting screw rod is installed at the holder body.

Optionally, the lifting guide rail includes a horizontal rod and a bottom rod. Two vertical rods are vertically disposed in parallel to each other at an interval. The horizontal rod is horizontally disposed, both ends thereof being respectively installed at the two vertical rods. The bottom rods is fixedly installed on the holder body, and one end that is of each of the vertical rod and that is far away from the horizontal rod is fixedly installed at the bottom rod. One end of the lifting screw rod is fixedly installed at the horizontal rod, and the other end of the lifting screw rod is fixedly installed at the bottom rod.

Optionally, the vertical-rod support includes a height gauge. The height gauge is vertically installed at the vertical rod for measuring a distance by which the cross beam assembly vertically moves.

Optionally, the cross beam assembly includes a supporting member and the guide rail. The supporting member includes a supporting body and a moving block. The moving block is fixedly installed on the supporting body and sleeved around the lifting screw rod, the moving block being in screw-thread fit with the lifting screw rod. The guide rail is fixedly and horizontally installed on the supporting body. The sliding member is movably installed on the guide rail and may move horizontally along the guide rail.

Optionally, the vertical-rod support includes a vertical rod, the vertical rod being vertically disposed. The supporting member includes a sliding block. The sliding block is fixedly installed on the supporting body, and sliding block is movably installed at the vertical rod and may slide along the vertical rod.

Optionally, two clamping portions respectively extend from two opposite sides of the supporting body. The two clamping portions are strip-shaped and are horizontally disposed in parallel to each other at an interval. The two guide rails are respectively installed on the two clamping portions and are horizontally disposed in parallel to each other at an interval of a preset distance. The sliding member is movably installed on the guide rail through a sliding bearing.

Optionally, the cross beam assembly includes a level gauge configured to detect whether the guide rail is horizontally disposed.

In the embodiments of the present invention, the technical problems are further resolved using the following technical solutions.

A method for demarcating a center line of an automobile body, including:

providing a holder apparatus and a laser, the holder apparatus having a horizontal scale;

moving the holder apparatus to a position in front of or behind a to-be-demarcated automobile, and keeping the holder apparatus away from the to-be-demarcated automobile by a preset distance, the horizontal scale being parallel to an axle of the to-be-demarcated automobile;

installing the two lasers at two positions that are symmetrically disposed along a center line of the to-be-demarcated automobile;

turning on the two lasers to respectively perform projection on the horizontal scale, so that two laser points of the two lasers respectively fall at both ends of the horizontal scale; and

according to readings of the two laser points on the horizontal scale, keeping the preset distance between the holder apparatus and the to-be-demarcated automobile unchanged, and adjusting a horizontal position of the holder apparatus relative to the to-be-demarcated automobile, to implement demarcation of the center line of the to-be-demarcated automobile.

Optionally, the holder apparatus includes a guide rail, and the horizontal scale is disposed on the guide rail. The horizontal scale extends along both sides of the guide rail respectively using a center of the guide rail as a zero point. The laser includes an emitting hole. The method further includes:

providing a reflecting mirror and a diaphragm, the reflecting mirror being installed on the guide rail and being horizontally movable along the guide rail;

moving the reflecting mirror to one end of the guide rail, so that a laser beam on a same side as the reflecting mirror irradiates at a reflecting face of the reflecting mirror; placing the diaphragm at a middle position between the laser and the reflecting mirror, and adjusting a diaphragm groove and the laser, so that the laser beam on the same side as the reflecting mirror is capable of passing through the diaphragm groove;

adjusting a position of the reflecting mirror, so that the laser beam can return back along an original path to project on the emitting hole; and

moving the reflecting mirror to a center of the guide rail, examining scale values of the laser points of the laser beams on both sides on the horizontal scale again, to determine whether demarcation of the center line of the to-be-demarcated automobile is completed.

Compared to the prior art, according to the device and the method for demarcating a center line of an automobile body in the embodiments of the present invention, the two lasers may be installed on both sides of the to-be-demarcated automobile, two laser beams equidistantly emitted using the center line of the to-be-demarcated automobile irradiate at the horizontal scale, and the holder apparatus may be moved to an appropriate position according to a scale value of the horizontal scale, thereby facilitating demarcation of the center line of the automobile.

In addition, according to the device and the method for demarcating a center line of an automobile body in the embodiments of the present invention, the reflecting mirror on one side of the automobile is moved to an irradiating area of the laser on the side, so that the laser point can be reflected back to an incidence direction thereof. The diaphragm is placed at a middle position between the laser and the reflecting mirror, so that an emitted laser beam can pass through the diaphragm groove and irradiates at the reflecting mirror. Therefore, the laser point reflected through the reflecting mirror may return to an emitting point of the laser, facilitating precise demarcation of the center line of the automobile.

### BRIEF DESCRIPTION OF THE DRAWINGS

One or more embodiments are described by way of example with reference to the corresponding figures in the accompanying drawings, and the descriptions are not to be construed as limiting the embodiments. Elements in the accompanying drawings that have same reference numerals are represented as similar elements, and unless otherwise particularly stated, the figures in the accompanying drawings are not drawn to scale.

FIG. 1 is a three-dimensional diagram of a device for demarcating a center line of an automobile according to an embodiment of the present invention;

FIG. 2 is a three-dimensional diagram of a holder apparatus of a demarcation device shown in FIG. 1;

FIG. 3 is a three-dimensional diagram of a holder apparatus shown in FIG. 2 from another perspective;

FIG. 4 is a front view of a holder apparatus shown in FIG. 2;

FIG. 5 is a three-dimensional diagram of a diaphragm of a demarcation device shown in FIG. 1;

FIG. 6 is a three-dimensional diagram of a diaphragm shown in FIG. 5 from another perspective;

FIG. 7 is a three-dimensional diagram of a laser of a demarcation device shown in FIG. 1;

FIG. 8 is a three-dimensional diagram of a laser shown in FIG. 7 from another perspective;

FIG. 9 is a schematic diagram of initial demarcation of a center line of an automobile performed by a demarcation device shown in FIG. 1;

FIG. 10 is a schematic diagram of precise demarcation of a center line of an automobile performed by a demarcation device shown in FIG. 1; and

FIG. 11 is a flowchart of a method for demarcating a center line of an automobile according to another embodiment of the present invention.

### DETAILED DESCRIPTION

For ease of understanding the disclosure, the disclosure is described in further detail below with reference to the accompanying drawings and specific embodiments. It should be noted that an element described as being “fixed” to another element may be directly on the other element, or one or more intervening components may be present. An element described as being “connected” or “attached” to another element may be directly connected to the other element, or one or more intervening components may be present. When an element is directly “connected” or “attached” to another element, the element can be connected to another element by a fastener (such as a screw) or by molding. In the case of molding, the two elements are molded into one piece. Similarly, an element described as being “mounted” or “installed” to another element may be directly mounted to the other element, or one or more intervening components may be present. An clcment can be mounted or installed to another element by a fastener, such as a screw. As used in the specification, orientation or position relationships indicated by the terms such as “perpendicular”, “horizontal”, “right”, “left”, “inside”, and “outside” and similar terms and are used only for description. Similarly, the terms “first” and “second” are the purpose of description only.

Unless otherwise defined, all technical and scientific terms used herein have the same meaning as commonly understood by one of ordinary skill in the art to which the disclosure belongs. The terms used in the specification of the disclosure are merely used for describing specific embodiments, and are not intended to limit the disclosure. As used herein, the term “and/or” includes any and all combinations of one or more related items listed.

In addition, the technical features provided in different embodiments of the disclosure to be described below may be combined with each other as long as no conflict occurs.

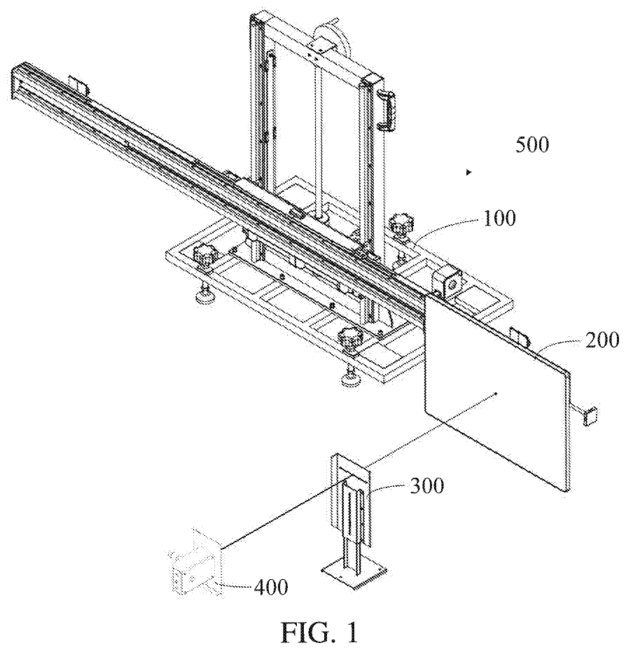

Referring to FIG. 1, a device 500 for demarcating a center line of an automobile according to an embodiment of the present invention includes a holder apparatus 100, a reflecting mirror 200, a diaphragm 300, and a laser 400. The reflecting mirror 200 is installed on the holder apparatus 100. The holder apparatus 100 is configured to support the reflecting mirror 200, and can drive the reflecting mirror 200 to horizontally or vertically move. The laser 400 is configured to emit a laser beam, the diaphragm 300 is configured to control whether the laser beam passes therethrough, and the reflecting mirror 200 is configured to reflect, to the laser 400, the laser beam that passes through the diaphragm 300.

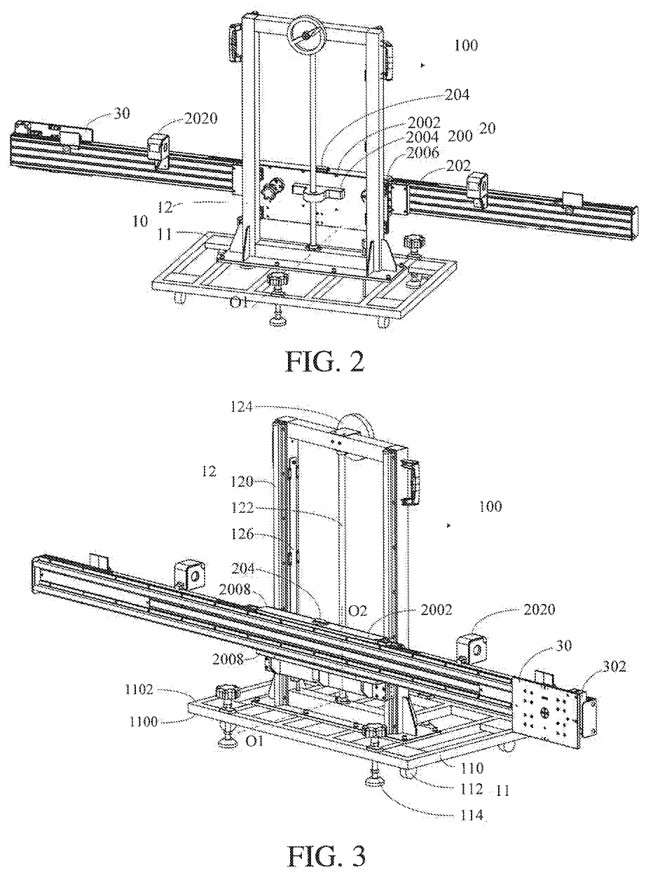

Referring to FIG. 2, the holder apparatus 100 includes a holder assembly 10, a cross beam assembly 20, and a sliding member 30. The cross beam assembly 20 is installed on the holder assembly 10 and may vertically move relative to the holder assembly 10. The sliding member 30 is installed on the cross beam assembly 20 and may horizontally move relative to the cross beam assembly 20. The reflecting mirror 200 is installed on the sliding member and may move horizontally with the sliding member 30 relative to the cross beam assembly 20.

The holder assembly 10 includes a base holder 11 and a vertical-rod support 12. One end of the vertical-rod support 12 is connected to the base holder 11, and the base holder 11 supports the vertical-rod support 12.

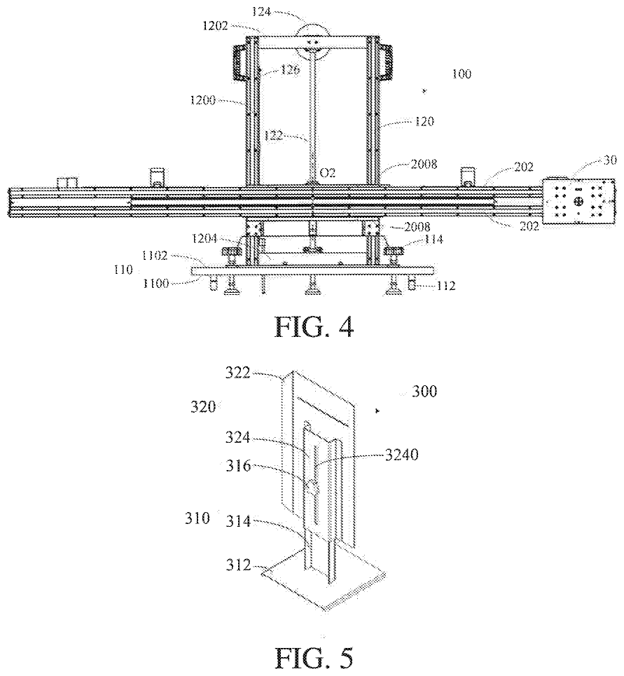

Referring to both FIG. 3 and FIG. 4, the base holder 11 includes a holder body 110, a rolling wheel 112, and a height adjusting member 114. The holder body 110 is a rectangular plate and may be made of metal. A plurality of hollow areas are formed to reduce a weight. The holder body 110 includes a bottom surface 1100 and an upper surface 1102 that are oppositely disposed. The holder body 110 has a central axis O1.

The rolling wheel 112 is installed on the bottom surface 1100 for facilitating movement of the base holder 11. In this embodiment, the rolling wheel 112 is an omni-directional moving wheel, so that the base holder 11 can move toward any direction. There are four rolling wheels 112 that are respectively installed at four corners of the holder body 110. It may be understood that, in some other embodiments, a shape of the holder body 110 may vary according to an actual demand, and is not limited to a rectangle. For example, the holder body 110 may be a circle. There may be more or fewer rolling wheels 112 according to an actual demand, provided that there are at least three rolling wheels.

The height adjusting member 114 is installed on the bottom surface 1100 for adjusting a height of the holder body 110. In this embodiment, the height adjusting member 114 is an adjusting hand wheel, and there are three adjusting hand wheels. For example, as shown in FIGS. 1-3, the height adjusting member 114 includes an adjustment screw. The three adjusting hand wheels 114 are distributed in a form of an isosceles triangle. Two adjusting hand wheels 114 located at a bottom edge of the isosceles triangle are disposed on one side of the holder body 110, and are symmetrically disposed along the central axis O1 of the holder body 110. The remaining adjusting hand wheel 114 is disposed on the other side of the holder body 110, and is disposed on the central axis O1 of the holder body 110 (that is, disposed at a top point of a vertex angle of the isosceles triangle). The three adjusting hand wheels 114 can adjust an overall horizontal angle of the holder body 110 through cooperation. Adjusting the adjusting hand wheel 114 located on the central axis O1 of the holder body 110 alone can adjust a pitch angle of the holder body 110.

It may be understood that the height adjusting member 114 may be other apparatuses that can adjust a height. There may be more height adjusting members 114 according to an actual demand, provided that there are at least three height adjusting members. Three of the at least three the height adjusting members 114 are disposed in the foregoing distribution manner.

The vertical-rod support 12 includes a lifting guide rail 120, a lifting screw rod 122, and a height gauge 126. In an embodiment, the vertical-rod support 12 may further includes a lifting crank 124.

The lifting guide rail 120 is installed on the holder body 110. The lifting guide rail 120 includes a vertical rod 1200, a horizontal rod 1202, and a bottom rod 1204. The two vertical rods 1200 are vertically disposed in parallel to each other at an interval for guiding the cross beam assembly 20 to move along a vertical direction. In the embodiment, the two vertical rods are two vertical guide rails configured to guide the cross beam assembly 20 to move along a vertical direction. The vertical rod can be a single rod that is used as a guide rail. Alternatively, the vertical rod is a component including a guide rail or a rod.

The horizontal rod 1202 is horizontally disposed, both ends thereof being respectively mounted to the two vertical rods 1200. The bottom rod 1204 is fixedly mounted on the holder body 110. One end that is of each of the vertical rods 1200 and that is far away from the horizontal rod 1202 is fixedly mounted to the bottom rod 1204.

It should be noted that the shape of the horizontal rod 1202 and the bottom rod 1204 is not limited in the application. For example, the horizontal rod 1202 may be rod-shaped or plate-shaped. Similarly, the bottom rod 1204 may be rod-shaped or plate-shaped.

It may be understood that, in some other embodiments, there may be more or fewer vertical rods 1200 according to an actual demand. For example, there may be one or three vertical rods 1200.

The lifting screw rod 122 is installed on the lifting guide rail 120 in the vertical direction. The lifting screw rod 122 is configured to rotate relative to the lifting guide rail 120. One end of the lifting screw rod 122 is installed at the horizontal rod 1202, and the other end of the lifting screw rod 122 is installed at the bottom rod 1204. In an embodiment, the lifting screw rod 112 is rotatably mounted to the lifting guide rail 120. For example, the lifting screw rod 112 can be mounted to the lifting guide rail 120 through a bearing. In some other embodiments, a first part of the lifting screw rod 112 is fixedly mounted to the lifting guide rail 120, and a second part of the lifting screw rod 112 is rotatable relative to the first part of the lifting screw rod 112. The second part of the lifting screw rod 112 is attached to a supporting member 200 and is rotatably attached to the first part of the lifting screw rod 112.

It may be understood that, in some other embodiments, the bottom rod 1204 may be omitted. One end that is of each of the vertical rod 1200 and that is far away from the horizontal rod 1202 is fixedly mounted on the holder body 110. The lifting screw rod 122 is mounted on the lifting guide rail 120 in the vertical direction. One end of the lifting screw rod 122 is installed at the horizontal rod 1202, and the other end of the lifting screw rod 122 is installed at the holder body 110.

The lifting crank 124 is installed at the horizontal rod 1202, and is connected to the lifting screw rod 122 for rotation, thereby driving the lifting screw rod 122 to rotate around a central axis of the lifting screw rod. In this embodiment, a connecting rod of the lifting crank 124 is perpendicular to the lifting screw rod 122, and is connected to the lifting screw rod 122 through a gear structure. It may be understood that, in some other embodiments, the connecting rod of the lifting crank 124 may be coaxial with the lifting screw rod 122, and the connecting rod of the lifting crank 124 is directly connected to the lifting screw rod 122. The lifting crank 124 is configured to manually rotate the lifting screw rod 122. Alternatively, the lifting crank 124 may be replaced with other apparatuses for driving the lifting screw rod 122 to rotate, for example, a motor, etc. In an embodiment, a power adaptor is provided, and the motor is a direct current (DC) motor. One end of the power adaptor is connected to a DC port of the motor, and the other end of the power adaptor is connected to an alternating current (AC) port. In some embodiments, the motor is an AC motor. With the help of the motor, the lifting screw rod 122 can be rotated automatically. In some other embodiments, the device 500 can include both a lifting crank 124 and a motor.

The height gauge 126 is vertically installed at the vertical rod 1200. The height gauge 126 has a graduation and is configured to measure a distance by which the cross beam assembly 20 vertically moves.

In an embodiment, the vertical-rod support 12 further includes a handle. For example, as shown in FIGS. 1-4, the vertical-rod support 12 includes a pair of handles. The number of handle is not limited in the application. In an embodiment, there is only one handle. In some other embodiments, there are three or four handles.

The cross beam assembly 20 includes a supporting member 200, a guide rail 202, and a level gauge 204. The supporting member 200 is installed on the lifting guide rail 120. Under guidance of the lifting guide rail 120, the supporting member 200 can vertically move relative to the lifting guide rail 120. The guide rail 202 is fixedly installed on the supporting member 200 and may vertically move with the supporting member 200 relative to the lifting guide rail 120. In an embodiment, the guide rail 202 may be formed by grooving a crossbeam of the cross beam assembly 20. In some other embodiments, the guide rail 202 is a separate component and is mounted to the crossbeam of the cross beam assembly 20. The sliding member 30 is installed on the guide rail 202 and may horizontally move relative to the guide rail 202.

The supporting member 200 includes a supporting body 2002, a moving block 2004, and a sliding block 2006.

The supporting body 2002 is approximately plate-shaped. Two clamping portions 2008 respectively extend from two opposite sides of the supporting body. The two clamping portions 2008 are strip-shaped and are horizontally disposed in parallel to each other at an interval. In some embodiments, only one elongated strip-shaped clamping portion 2008 is provided. The one clamping portion extends from a lower side of the supporting body 2002 or is mounted to a lower side of the supporting body 2002. The clamping portion(s) is/are provided so that the guide rail 202 can be mounted easily.

The moving block 2004 is fixedly mounted on the supporting body 2002 and is sleeved around the lifting screw rod 122. The moving block 2004 is in screw-thread fit with the lifting screw rod 122. When the lifting screw rod 122 rotates around a central axis thereof, the moving block 2004 may be driven to move along the lifting screw rod 122 in the vertical direction, thereby driving the cross beam assembly 20 to vertically move. The moving block 2004 and the clamping portion 2008 are respectively located on two opposite sides of the supporting body 2002. That is, the guide rail 202 and the movable block 2004 are located on two opposite sides of the supporting body 2002.

The sliding block 2006 is fixedly mounted on the supporting body 2002. The sliding block 2006 and the moving block 2004 are located on a same side of the supporting body 2002. At least one sliding block 2006 is correspondingly installed on each of the vertical rods 1200. Each sliding block 2006 is movably installed on a corresponding vertical rod 1200, and may slide along the corresponding vertical rod 1200. In the embodiment, two sliding blocks 2006 are correspondingly installed on each of the vertical rods 1200. It may be understood that, in some other embodiments, according to an actual demand, there may be more or fewer sliding blocks 2006 correspondingly installed on each of the vertical rods 1200. For example, the number of the sliding block may be decreased to one or increased to three.

As shown in FIG. 2, the moving block 2004 is mounted on a middle part of the supporting body 2002. The sliding blocks 2006 are located on both ends of the supporting body 2002. The moving block 2004 is located between the sliding block(s) mounted to one of the two vertical rods 1200 and the sliding block(s) mounted to another of the two vertical rods 1200.

Two guide rails 202 are correspondingly installed on the two clamping portions 2008 respectively, and are horizontally disposed in parallel to each other at an interval of a preset distance. On both sides of the guide rail 202, there are horizontal scales 2020 that extend along both sides respectively. The horizontal scales use a center of the guide rail as a zero point. Alternatively, the horizontal scales 2020 are disposed at both ends of the guide rail 202. Therefore, positioning of a location of the sliding member is facilitated. As shown in FIGS. 1-4, there are two sides on the guide rail 202, left side and a right side. The two sides are on a same plane. In an embodiment, the left side and the right side take the center of the guide rail 202 as a boundary. One horizontal scale is disposed on the left side of the guide rail 202, and another horizontal scale is disposed on the right side of the guide rail 202. In an embodiment, the horizontal scale disposed on the left side is a mirror of the horizontal scale disposed on the right side. In some embodiments, the two horizontal scales are respectively disposed on two ends of the guide rails.

In an embodiment, the horizontal scale disposed on the left side is spaced apart from the horizontal scale disposed on the right side. In some other embodiments, there is no space between the horizontal scale disposed on the left side and the horizontal scale disposed on the right side. The horizontal scale disposed on the left side is connected to the horizontal scale disposed on the right side.

A central axis O2 of the guide rail 202 and the central axis O1 of the holder body 110 are at a same plane. It may be understood that, in some other embodiments, there may be more or fewer guide rails 202 according to an actual demand. For example, the number of the guide rail may be decreased one or increased to three. The guide rail 202 may also be fixedly mounted on the supporting member 200 in any other appropriate manner. For example, the clamping portion 2008 is omitted, and the guide rail 202 is directly welded on the supporting body 2002.

The level gauge 204 is installed on an upper side of the clamping portion 2008 for detecting whether the clamping portion 2008 is horizontally disposed, thereby determining whether the guide rail 202 is horizontally disposed. It may be understood that, in some other embodiments, the level gauge 204 may also be installed on the guide rail 202 or installed on other portions of the cross beam assembly 20, such as a calibration pattern, provided that the level gauge can be configured to detect whether the guide rail 202 is horizontally disposed.

The sliding member 30 is movably installed on the guide rail 202 and may horizontally move along the guide rail 202. In an embodiment, the sliding member 30 is movably installed on the guide rail 202 through a sliding bearing 302. The sliding member 30 includes several mounting points for installing the reflecting mirror 200. It may be understood that, in some other embodiments, the sliding member 30 may be movably installed on the guide rail 202 in other appropriate manners. For example, the sliding bearing 302 is omitted, and the sliding member 30 is directly installed on the guide rail 202.

In an embodiment, the holder apparatus 100 includes at least two sliding members 30, and each of the at least two sliding members 30 is configured to mount a laser. In some other embodiments, at least two lasers are fixedly mounted on the guide rail 202.

Referring to FIG. 1, the reflecting mirror 200 is installed on a mounting point. The reflecting mirror 200 is rectangularly tabular, and includes a reflecting face configured to reflect, to the laser 400, a laser beam that passes through the diaphragm 300.

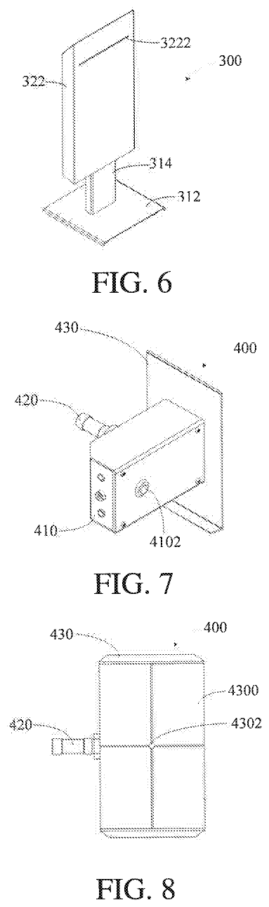

Referring to both FIG. 5 and FIG. 6, the diaphragm 300 includes a fixing base 310 and a sliding diaphragm 320.

The fixing base 310 includes a base 312, a fixing support 314, and a locking handle 316. The base 312 is rectangularly tabular. One end of the fixing support 314 is installed at a center of the base 312, and the fixing support 314 is perpendicular to the base 312. The fixing support 314 is strip-shaped. The locking handle 316 is installed on the fixing support 314.

The sliding diaphragm 320 includes a diaphragm portion 322 and a sliding groove portion 324. The diaphragm portion 322 is approximately tabular and provided with a strip-shaped diaphragm groove 3222 for allowing a laser beam to pass therethrough. A width of the diaphragm groove 3222 is slightly less than a diameter of a laser point emitted by the laser 400, so as to detect whether the laser beam just passes through the diaphragm groove 3222. The sliding groove portion 324 is installed at the diaphragm portion 322 and is strip-shaped, and is sleeved around the fixing support 314. The sliding groove portion 324 may slide relative to the fixing support 314. The sliding groove portion 324 is provided with a strip-shaped groove 3240. The locking handle 316 passes through the groove 3240 for stably fixing the sliding diaphragm 320 on the fixing base 310.

Referring to both FIG. 7 and FIG. 8, the laser 400 is a wheel laser, including an emitting portion 410, an installing shaft 420, and an observing target 430. The emitting portion 410 is configured to emit a laser beam, and the emitting portion 410 includes a switch 4102 for turning on or turning off the emitting portion 410. The installing shaft 420 is installed on the emitting portion 410 for installing the wheel laser 400 on a wheel of the automobile. The observing target 430 is mounted on the emitting portion 410. The observing target 430 is a rectangular plate, and includes an observing target face 4300 for displaying a position of a laser beam reflected back through the reflecting mirror 200. An emitting hole 4302 is provided at a center of the observing target face 4300 for allowing a laser beam to be emitted.

In an embodiment, the observing target face 4300 of the laser 400 further displays a position of a laser beam emitted from the laser mounted on the guide rail 202.

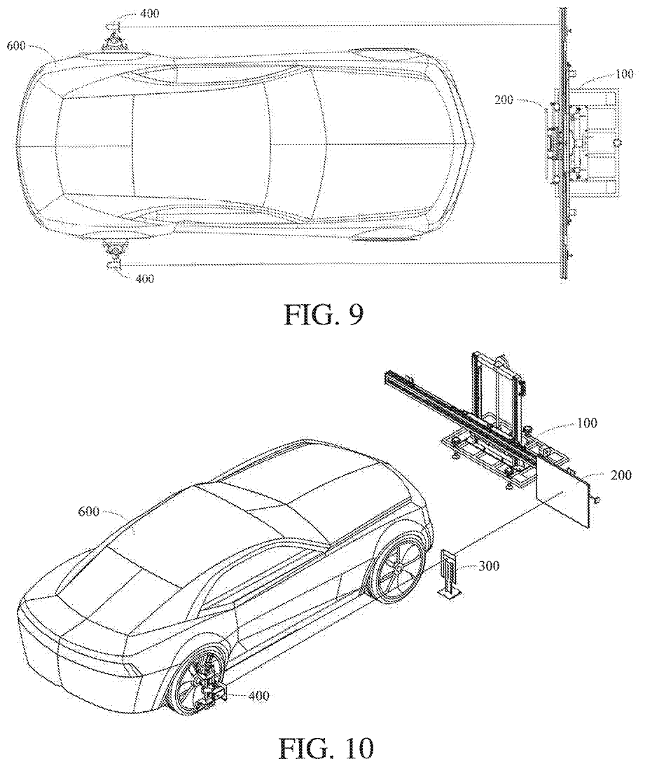

Referring to FIG. 9, in a first step, the holder apparatus 100 is moved to a position in front of a to-be-demarcated automobile 600 through the rolling wheel 112 and is one meter away from the to-be-demarcated automobile. The reflecting mirror 200 is installed on the sliding member 30, and is moved to a center of the guide rail 202 (that is, a vertically central axis of the reflecting mirror 200 and the central axis O2 of the guide rail 202 are at a same plane), and the guide rail 202 is parallel to an axle of the automobile 600. Wheel clamps are respectively installed on rear wheels of the automobile 600, and the lasers 400 are respectively mounted on the wheel clamps. The lasers 400 are turned on to respectively cast a laser beam on both ends of the guide rail 202. Angles of the lasers 400 are adjusted, so that laser points fall on the horizontal scales 2020 on both ends of the guide rail 202, and readings of laser points on both ends are recorded. If the readings are the same, the central axis O2 of the guide rail 202 is at the center line of the automobile 600. If the readings are different, the holder apparatus 100 is horizontally moved until the readings are the same. At this moment, only initial alignment of the center line is completed. Since there is a specific angle difference between the guide rail 202 and the axle, and the angle difference cannot be removed using the foregoing method, precise demarcation of the center line of the automobile 600 needs to be further performed.

Referring to FIG. 10, in a second step, the reflecting mirror 200 is moved to one end of the guide rail 202, so that the laser on the same side as the reflecting mirror 200 can irradiate at a reflecting surface of the reflecting mirror. The diaphragm 300 is placed at a middle position between the laser 400 and the reflecting mirror 200, and the diaphragm portion 322 is perpendicular to the laser beam. The diaphragm groove 3222 is adjusted to be as high as the emitting hole 4302 of the laser 400. An angle at which the laser 400 is emitted is adjusted, and a position of the diaphragm 300 is properly moved, so that the laser beam can pass through a center of the diaphragm groove 3222. A position of the reflecting mirror 200 is adjusted according to a practical situation, so that the current laser beam can irradiate at the reflecting mirror 200. A position of a laser point reflected back is observed, and the height adjusting member 114 is adjusted, so that the laser beam reflected through the reflecting mirror 200 can just return back along an original path and be projected to the emitting hole 4302 of the laser 400.

After the foregoing step is completed, the reflecting mirror 200 is moved to the center of the guide rail 202. It is determined again whether graduations of the projections of the lasers 400 on both sides of the guide rail 202 are the same. If yes, it indicates that demarcation of the center line and a vertical face thereof of the automobile 600 is completed. Otherwise, the foregoing second step is required to be repeated.

It may be understood that, in some other embodiments, the holder apparatus 100 may be disposed at a rear portion of the automobile 600, and the two laser 400 are installed on two front wheels of the automobile 600, so that the center line of the automobile 600 can be also demarcated at the rear portion of the automobile 600. Alternatively, the holder apparatus 100 may be disposed at a front portion or a rear portion of the automobile 600, and the two lasers 400 are installed at two positions that are symmetrically disposed along the center line of the automobile 600, so that the center line of the automobile 600 can also be demarcated at the front portion or the rear portion of the automobile 600.

In some other embodiments, there is an alternative method in the second step. Two lasers are respectively mounted on the guide rail 202. The two lasers are mounted at two positions that are symmetrically disposed relative to a center point of the guide rail 202. The positions at which the lasers are mounted can be known with the help of the horizontal scales that are respectively disposed on both sides of the guide rail 202. The two laser 400 are respectively mounted on the rear wheels or the front wheels, optionally through wheel clamps. The observing target face 4300 of each of the two laser 400 is provided with a horizontal scale. The two lasers on the guide rail 202 respectively emit a laser beam, and the two laser beams are respectively projected on the observing target faces 4300 of the lasers 400. Adjust position of the guide rail 202 (or the holder apparatus 100) and/or positions of the lasers on the guide rail 202, so that readings of laser points on the horizontal scales of the two lasers 400 are the same. Once the readings on the horizontal scales of the two lasers 400 are the same, the angle difference is removed using the method in the first step.

Compared to the prior art, according to the device 500 for demarcating a center line of an automobile in this embodiment of the present invention, the two lasers 400 may be installed on wheels on both sides of the automobile 600, two laser beams equidistantly emitted using the wheels as reference points irradiate at the horizontal scales 2020 of the guide rail 202, and the guide rail 202 is moved to an appropriate position according to graduations of the horizontal scales 2020, so that readings of the irradiated lasers on both sides are the same, thereby facilitating initial demarcation of the center line of the automobile 600.

In addition, at one side of the automobile 600, the reflecting mirror 200 is then moved to an irradiation area of the laser 400 at the one side, so that a laser point can be reflected back to an incidence direction thereof. The diaphragm 300 is placed at a middle position between the laser 400 and the reflecting mirror 200, the diaphragm portion 322 is perpendicular to the laser beam, and a height of the diaphragm groove 3222 is adjusted to a height of the laser 400. An angle at which the laser 400 is emitted is first adjusted, so that an emitted laser beam can pass through the diaphragm groove 3222 and irradiate at the reflecting mirror 200. The height adjusting member 114 is adjusted, so that the laser point reflected through the reflecting mirror 200 can return to an emitting point of the laser 400, facilitating precise demarcation of the center line of the automobile 600.

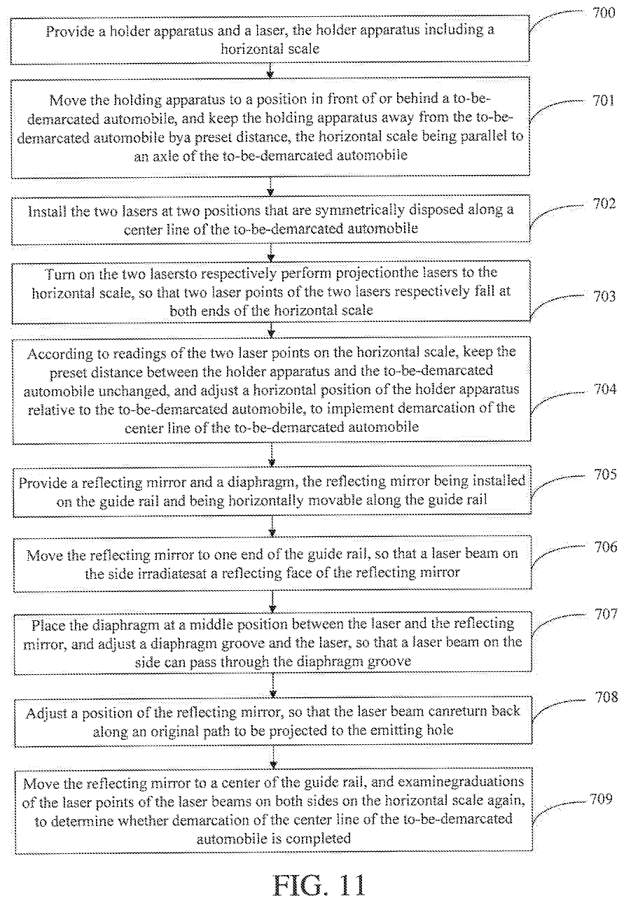

Another embodiment of the present invention provides a method for demarcating a center line of an automobile. The method is implemented using the foregoing device 500 for demarcating a center line of an automobile provided in the foregoing embodiment. Referring to FIG. 11, the method includes the following steps.

700: A holder apparatus and a laser are provided, the holder apparatus including a horizontal scale.

701: The holder apparatus is moved to a position in front of or behind a to-be-demarcated automobile, and the holder apparatus is kept away from the to-be-calibrated automobile by a preset distance, the horizontal scale being parallel to an axle of the to-be-demarcated automobile.

The holder apparatus 100 is moved to a front portion of the to-be-calibrated automobile 600 through the rolling wheel 112, and is about one meter away from the to-be-calibrated automobile. The horizontal scale 2020 is horizontally disposed in parallel to an axle of the to-be-demarcated automobile 600.

702: The two lasers are installed at two positions that are symmetrically disposed along a center line of the to-be-demarcated automobile.

For example, wheel clamps may be respectively installed on rear wheels of the to-be-demarcated automobile 600, and the two lasers 400 are installed on the wheel clamps.

703: The two lasers are turned on to respectively cast a laser beam on the horizontal scale, so that two laser points of the two lasers respectively fall on both ends of the horizontal scale.

Angles of the lasers 400 are adjusted, so that the laser points fall on both ends of the horizontal scale 2020.

704: According to readings of the two laser points on the horizontal scale, the preset distance between the holder apparatus and the to-be-calibrated automobile is kept unchanged, and a horizontal position of the holder apparatus relative to the to-be-demarcated automobile is adjusted, so as to implement demarcation of the center line of the to-be-demarcated automobile.

Readings of the laser points on both ends of the horizontal scale 2020 are recorded. If the readings are the same, a center of the horizontal scale 2020 is at a center line of the to-be-demarcated automobile 600. If the readings are different, the holder apparatus 100 is horizontally moved until the readings are the same.

At this moment, only initial alignment of the center line is completed. Since there is a specific angle difference between the horizontal scale 2020 and the axle, and the angle difference cannot be removed using the foregoing method. Therefore, precise demarcation of the center line of the automobile 600 needs to be further performed. In some embodiments, the holder apparatus 100 includes a guide rail 202, the horizontal scale 2020 is disposed on the guide rail 202. The horizontal scales 2020 extend along both sides of the guide rail 202 respectively using a center of the guide rail 202 as a zero point. The laser 400 includes an emitting hole 4302. The method further includes the following steps.

705: A reflecting mirror and a diaphragm are provided. The reflecting mirror is installed on the guide rail and is horizontally movable along the guide rail.

706: The reflecting mirror is moved to one end of the guide rail, so that a laser beam on the same side as the reflecting mirror irradiates at a reflecting face of the reflecting mirror.

707: The diaphragm is placed at a middle position between the laser and the reflecting mirror, and the diaphragm groove and the laser are adjusted, so that a laser beam on the same side as the reflecting mirror can pass through the diaphragm groove.

The diaphragm 300 is placed at a middle position between the laser 400 and the reflecting mirror 200, and the diaphragm portion 322 is perpendicular to the laser beam. The diaphragm groove 3222 is adjusted to be as high as the emitting hole 4302 of the laser 400. An angle at which the laser 400 is emitted is adjusted, and a position of the diaphragm 300 is properly moved, so that the laser beam can pass through a center of the diaphragm groove 3222.

708: A position of the reflecting mirror is adjusted, so that the laser beam can return back along an original path to project on the emitting hole.

A position of the reflecting mirror 200 is adjusted according to a practical situation, so that the current laser beam can irradiate at the reflecting mirror 200. A position of a laser point reflected back is observed, and the reflecting mirror 200 is adjusted, so that the laser beam reflected from the reflecting mirror 200 can return back along an original path to be projected to the emitting hole 4302 of the laser 400.

709: The reflecting mirror is moved to a center of the guide rail, graduations of the laser points of the laser beams on both sides on the horizontal scale are examined again, to determine whether demarcation of the center line of the to-be-calibrated automobile is completed.

The reflecting mirror 200 is moved to the center of the guide rail 202. It is determined again whether projected scale values of the laser points of the laser beams on the horizontal scale 2020 are the same. If yes, it indicates that demarcation of the center line and a vertical face of the automobile 600 is completed.

Further, another method for demarcating a center line of an automobile is provided in an embodiment of the application. This method includes the steps 700-704, and the steps 705-709 are replaced with the following steps a-c.

Step a: Providing two lasers on a guide rail 202 of the holder apparatus 100. The two lasers are mounted at two positions that are symmetrically disposed relative to a center point of the guide rail 202.

The positions at which the lasers are mounted can be known with the help of the horizontal scales that are respectively disposed on both sides of the guide rail 202.

Step b: Turning on the two lasers on the guide rail 202. The two lasers respectively emit a laser beam, so that two laser points of the two lasers on the guide rail 202 respectively fall on both horizontal scales of the two lasers 400.

Adjust positions of the lasers on the guide rail 202, so that the two laser points of the two lasers on the guide rail fall on the horizontal scales of two lasers 400.

Step c: Reading positions of laser points on horizontal scales on the lasers 400. If the readings on the horizontal scales of the two lasers 400 are the same, the demarcation of the center line of the automobile is completed. If the readings on the horizontal scales of the two lasers 400 are different, rotate the holder apparatus 100 around the central axis O2 of the guide rail 202, until the readings on the horizontal scales of the two lasers 400 are the same.

It should be noted that, in the embodiments of the present invention, the method is implemented using the device 500 for demarcating a center line of an automobile provided in the foregoing embodiment. For technical details that are not described in detail in the method embodiments, reference may be made to the descriptions of the device 500 for demarcating a center line of an automobile provided in the embodiments of the present invention.

Compared to the prior art, in the method for demarcating a center line of an automobile in the embodiments of the present invention, two laser beams equidistantly emitted from the center line of the to-be-calibrated automobile 600 irradiate at the horizontal scales 2020, and a horizontal position of the holder apparatus 100 relative to the to-be-demarcated automobile 600 is adjusted according to the graduations of the horizontal scales 2020, thereby facilitating initial demarcation of the center line of the to-be-demarcated automobile 600.

In addition, on one side of the to-be-calibrated automobile 600, the reflecting mirror and the diaphragm 300 may be used to facilitate precise demarcation of the center line of the automobile 600.

It should be finally noted that the above embodiments are merely intended for describing the technical solutions of the present invention rather than limiting the present invention. Based on the idea of the disclosure, the technical features in the foregoing embodiments or different embodiments may be combined, the steps may be implemented in any order, and many other changes in the different aspects of the disclosure as described above may exist. For brevity, such changes are not provided in the detailed descriptions. Although the disclosure is described in detail with reference to the foregoing embodiments, those of ordinary skill in the art should understand that they can still make modifications to the technical solutions described in the foregoing embodiments or make equivalent substitutions to some technical features thereof, without departing from scope of the technical solutions of the embodiments of the disclosure.

What is claimed is:

1. A device for demarcating a center line of an automobile, comprising:
a holder apparatus comprising:
a holder assembly; and
a cross beam assembly mounted on the holder assembly, the cross beam assembly being movable relative to the holder assembly along a vertical direction, the cross beam assembly comprising a guide rail, the guide rail being horizontally disposed, horizontal scales being respectively disposed on both sides of the guide rail;
wheel clamps configured to be respectively mounted on rear wheels or front wheels of the automobile; and
two lasers, the two lasers being respectively disposed on both sides of the automobile, the two lasers being respectively mounted on the wheel clamps, the two lasers being configured to cast two laser beams on the horizontal scales;
wherein each of the two lasers comprises:
an emitting portion configured to emit a laser beam to a corresponding horizontal scale of the horizontal scales; and
an observing target mounted on the emitting portion, the observing target comprising an observing target face, an emitting hole being provided on the observing target face to allow the laser beam to be emitted, the observing target face being configured to display a position of a laser beam;
wherein the holder assembly is configured to be adjustable so that readings of two laser points of the two lasers on the horizontal scales are the same.

2. The device according to claim 1, wherein the horizontal scales are respectively disposed on both ends of the guide rail.

3. The device according to claim 1, wherein the observing target is a rectangular plate.

4. The device according to claim 1, wherein the emitting hole is provided at a center of the observing target face.

5. The device according to claim 1, wherein the emitting portion comprises a switch configured to turn on or turn off the emitting portion.

6. The device according to claim 1, wherein each of the two lasers further comprises an installing shaft installed on the emitting portion, the installing shaft being configured to mount the each of the two lasers.

7. The device according to claim 1, further comprising two lasers mounted on the guide rail, the two lasers on the guide rail being mounted at two positions that are symmetrically disposed relative to a center of the guide rail.

8. The device according to claim 7, further comprising two sliding members movably mounted on the guide rail, the two lasers on the guide rail being respectively mounted on the two sliding members.

9. The device according to claim 7, wherein a horizontal scale is provided on the observing target face of each of the two lasers that are mounted on wheel clamps;
each of the two lasers on the guide rail being configured to cast a laser beam on a corresponding horizontal scale of the two lasers mounted on the wheel clamps;
wherein the holder assembly is adjustable so that readings of laser points on the horizontal scales of the two lasers mounted on the wheel clamps are the same.

10. The device according to claim 7, wherein the observing target face is configured to display a position of a laser beam emitted from a corresponding laser on the guide rail.

11. The device according to claim 1, further comprising:
a diaphragm configure to control a laser beam emitted from one laser of the two lasers to pass therethrough; and
a reflecting mirror disposed on the guide rail and configured to reflect, to the one laser, the laser beam passing through the diaphragm.

12. The device according to claim 11, wherein the observing target face is configured to display a position of a laser beam reflected back through the reflecting mirror.

13. The device according to claim 1, wherein the holder assembly comprises:
a base holder; and
a vertical-rod support mounted on the base holder, the vertical-rod support comprising a lifting screw rod, the lifting screw rod being configured to drive the cross beam assembly to move along the lifting screw rod in the vertical direction when the lifting screw rod rotates.

14. The device according to claim 13, wherein the holder assembly further comprises a motor configured to drive the lifting screw rod to rotate.

15. The device according to claim 13, wherein the holder assembly further comprises a lifting crank configured to manually rotate the lifting screw rod.

16. The device according to claim 13, wherein the vertical-rod support comprises two vertical rods, the two vertical rods being vertically disposed in parallel to each other at an interval, the two vertical rods being configured to guide the cross beam assembly to move along the vertical direction.

17. The device according to claim 16, wherein the cross beam assembly comprises a supporting member, the supporting member comprising:
a supporting body, the guide rail being mounted on the supporting body;
a moving block fixedly mounted on the supporting body, the moving block being in screw-thread fit with the lifting screw rod, the lifting screw rod being configured to drive the moving block to move along the lifting screw rod in the vertical direction; and
a sliding block fixedly mounted on the supporting body, the sliding block being movably mounted on each of the two vertical rods.

18. The device according to claim 17, wherein two sliding blocks are movably installed on each of the two vertical rods.

19. The device according to claim 17, wherein the moving block and the sliding block are disposed on a same side of the supporting body, the moving block and the guide rail being disposed on two opposite sides of the supporting body.

20. The device according to claim 17, wherein the moving block is disposed between the sliding block mounted on one of the two vertical rods and the sliding block mounted on another of the two vertical rods.

21. A device for demarcating a center line of automobile, comprising:
a holder apparatus comprising:
a holder assembly; and
a cross beam assembly mounted on the holder assembly, the cross beam assembly being movable relative to the holder assembly along a vertical direction, the cross beam assembly comprising a guide rail, the guide rail being horizontally disposed, horizontal scales being respectively disposed on both sides of the guide rail; and
at least two lasers, wherein two lasers of the at least two lasers are symmetrically disposed along the center line of the automobile, the two lasers being configured to cast two laser beams on the horizontal scales;
wherein the holder assembly is configured to be adjustable so that readings of two laser points of the two lasers on the horizontal scales are the same.

22. The device according to claim 21, wherein each of the two lasers comprises:
an emitting portion configured to emit a laser beam to a corresponding horizontal scale of the horizontal scales; and
an observing target mounted on the emitting portion, the observing target comprising an observing target face, the observing target face being configured to display a position of a laser beam, an emitting hole being provided on the observing target face.

23. The device according to claim 22, wherein the observing target is a rectangular plate.

24. The device according to claim 22, wherein the emitting hole is provided at a center of the observing target face.

25. The device according to claim 22, wherein the emitting portion comprises a switch configured to turn on or turn off the emitting portion.

26. The device according to claim 22, wherein each of the two lasers further comprises an installing shaft installed on the emitting portion, the installing shaft being configured to mount the each of the two lasers.

27. The device according to claim 21, wherein the horizontal scales are respectively disposed on both ends of the guide rail.

28. The device according to claim 21, wherein the two lasers are respectively mounted on rear wheels or front wheels of the automobile.

29. The device according to claim 21, further comprising wheel clamps configured to be respectively mounted on rear wheels or front wheels of the automobile;
the two lasers being respectively mounted on the wheel clamps.

30. A method for demarcating a center line of an automobile, comprising:
providing a holder apparatus and two lasers, the holder apparatus comprising a guide rail, horizontal scales being respectively disposed on both sides of the guide rail;
moving the holder apparatus to a position in front of or behind the automobile;
keeping the holder apparatus away from the automobile by a preset distance, the horizontal scales being parallel to an axle of the automobile;
installing the two lasers at two positions that are symmetrically disposed along the center line of the automobile;
turning on the two lasers to respectively cast a laser beam on the horizontal scales, so that two laser points of the two lasers respectively fall on the horizontal scales; and
according to readings of the two laser points on the horizontal scales, keeping the preset distance between the holder apparatus and the automobile unchanged, and adjusting a horizontal position of the holder apparatus relative to the automobile so that readings of the two laser points on the horizontal scales are the same.
